(19) United States
(12) Patent Application Publication
(10) Pub. No.: US 2014/0064812 A1
(43) Pub. Date: Mar. 6, 2014

(54) BOWED AND NON-PARALLEL ROLLERS FORMING NIP

(71) Applicants: Yu Liu, Mississauga (CA); Johann E. Junginger, Toronto (CA); Vladislav Skorokhod, Vaughan (CA)

(72) Inventors: Yu Liu, Mississauga (CA); Johann E. Junginger, Toronto (CA); Vladislav Skorokhod, Vaughan (CA)

(73) Assignee: XEROX Corporation, Norwalk, CT (US)

(21) Appl. No.: 13/603,514

(22) Filed: Sep. 5, 2012

(51) Int. Cl. G03G 15/00; B65G 13/12

(52) U.S. Cl. 399/361; 198/782

(57) ABSTRACT

A pair of opposing rollers comprises a first roller and a second roller contacting the first roller to form a nip between the rollers through which print media passes. Because of surface irregularities in the rollers, the nip can have one or more unintended gaps at locations where the surface of the first roller separates from the surface second roller. Further, a frame holds the first roller and the second roller. A manual or automatic axis adjuster is operatively connected to the controller and the first roller. The axis adjuster changes the angle of the axis (a first axis) of the first roller relative to the axis (a second axis) of the second roller based on the gap to position the first axis in a position other than parallel to the second axis. Changing the angle of the first axis relative to the second axis reduces or eliminates the gap.

### BACKGROUND

Embodiments herein generally relate to devices using rollers and more particularly to adjusting the relative axis of adjacent rollers to reduce gaps in the nip between the rollers.

Many devices, such as printing devices use pairs of opposing rollers to form a nip where the rollers contact. Conformal contact in the nip between such rollers, as increasingly important components on imaging apparatus, is useful for uniformity and efficiency. Such rollers can include bias charging roller (BCR) and drum photoreceptor (PR), fountain roller and metering roller, fuser roller and pressure roller, oil delivery roll and PR/BCR, etc.

While designed to have a constant diameter, in practice, the outer roller surface is not always perfectly straight (and the coated surface of the roller may not always be flat). As a result, efficient conformal contact between two rollers with bumpy surfaces has been routinely implemented by deforming a thick elastomeric layer of one or two rollers. Such deformation is large and the required pre-load to cause the deformation is high. Further, this presents challenges when applied on a high respect ratio miniature roller, especially with a thin layer coating in the range of 10 μm-1 mm. Sometimes even complete yield deformation of the thin layer coating may not completely seal the gap between two roller surfaces.

### SUMMARY

A pair of opposing rollers comprises a first roller and a second roller contacting the first roller to form a nip between the rollers. Surfaces of the first roller and the second roller can have different hardness measures. Further, the surface of each roller is substantially parallel to the roller axis along the full length of each roller (from one end of each roller to the opposite end of each roller) and the diameter of each roller is substantially consistent along the full length of each roller. Because of surface curves and irregularities caused by wear, manufacturing tolerances, etc., in the rollers surfaces (as opposed to intended diameter changes of cone shaped or elliptical rollers) the nip can have one or more unintended gaps (or areas of reduced nip pressure) at locations where the surface of the first roller separates from the surface second roller.

A frame holds the first roller and the second roller. Further, the frame applies force to ends of the first roller to bow the first roller toward the second roller. An optional detector (optical detector, pressure detector, electrical/inductive detector, air pressure detector, sonic detector, etc.) can be operatively connected to the controller and can automatically measure such gaps. A manual or automatic axis adjuster is operatively connected to the controller, the detector, and the first roller. For example, the axis adjuster can be any structure from a manual screw adjuster to a fully automated actuator. The axis adjuster (potentially automatically and dynamically) changes the angle of the axis of the first roller (a first axis) relative to the axis of the second roller (a second axis) based on the gap to position the first axis in a position other than parallel to the second axis. The axis adjuster can adjust the first axis in a single plane or in multiple planes.

The adjuster changes the angle of the first axis relative to the second axis to reduce or eliminate the gap. More specifically, changing the angle of the first axis relative to the second axis reduces or eliminates one or more of the gaps, without increasing other gaps and without forming additional gaps. Therefore, changing the angle of the first axis relative to the second axis makes the contact between the two rollers more uniform, and allows the amount of pressure exerted between the rollers to be decreased, relative to a non-bowed, parallel roller structure. The angle of the first axis of the first roller relative to the second axis of the second roller can be, for example, from about 0.01° to about 30°, and the gap between the pair of opposing rollers can be, for example, from about 1 μm to about 1 mm. Also, the aspect ratio of the first roller can be larger than the aspect ratio of the second roller.

An exemplary method embodiment herein measures the gap between the pair of opposing rollers. This exemplary method also adjusts the axis adjuster to change the angle of the first axis of the first roller relative to the second axis of the second roller to position the first axis in a position other than parallel to the second axis. Again, changing the angle of the first axis relative to the second axis reduces or eliminates the gap.

These and other features are described in, or are apparent from, the following detailed description.

### BRIEF DESCRIPTION OF THE DRAWINGS

Various exemplary embodiments of the systems and methods are described in detail below, with reference to the attached drawing figures, in which:

FIG. 1 is a perspective-view schematic diagram of a device according to embodiments herein;

FIG. 2 is a side-view schematic diagram of a device according to embodiments herein;

FIG. 3 is an end-view diagram of a device according to embodiments herein;

FIG. 4 is diagram illustrating angles of a device according to embodiments herein;

FIG. 5 is a perspective-view schematic diagram of a device according to embodiments herein;

FIG. 6 is a perspective-view schematic diagram of a device according to embodiments herein;

FIG. 7 is a perspective-view schematic diagram of a device according to embodiments herein;

FIG. 8 is a side-view schematic diagram of a device according to embodiments herein;

FIG. 9 is a top-view schematic diagram of a device according to embodiments herein;

FIG. 10 is a perspective-view schematic diagram of a device according to embodiments herein;

FIG. 11 is a side-view schematic diagram of a device according to embodiments herein;

FIG. 12 is a top-view schematic diagram of a device according to embodiments herein;

FIG. 13 is a perspective-view schematic diagram of a device according to embodiments herein;

FIG. 14 is a side-view schematic diagram of a device according to embodiments herein;

FIG. 15 is a top-view schematic diagram of a device according to embodiments herein;

FIG. 16 is a flow diagram illustrating embodiments herein; and

FIG. 17 is a side-view schematic diagram of a device according to embodiments herein.

### DETAILED DESCRIPTION

As mentioned above, nips formed between rollers with bumpy surfaces presents challenges to completely sealing the gap between the two roller surfaces. In view of such challenges, the methods and devices herein provide a non-parallelism method/structure to create efficient conformal contact between two roller surfaces. These methods and devices align the axes of two rollers in a non-parallelism position. Particularly, one roller is actively bent towards the other roller to make good conformal contact. This produces reduced deformation, reduced pre-load and less rigorous requirements on alignment tolerance. These methods and devices are generic and beneficial for efficient conformal contact of a roller, especially miniature rollers with a thin layer coating having a thickness from about 1 μm to 1 mm.

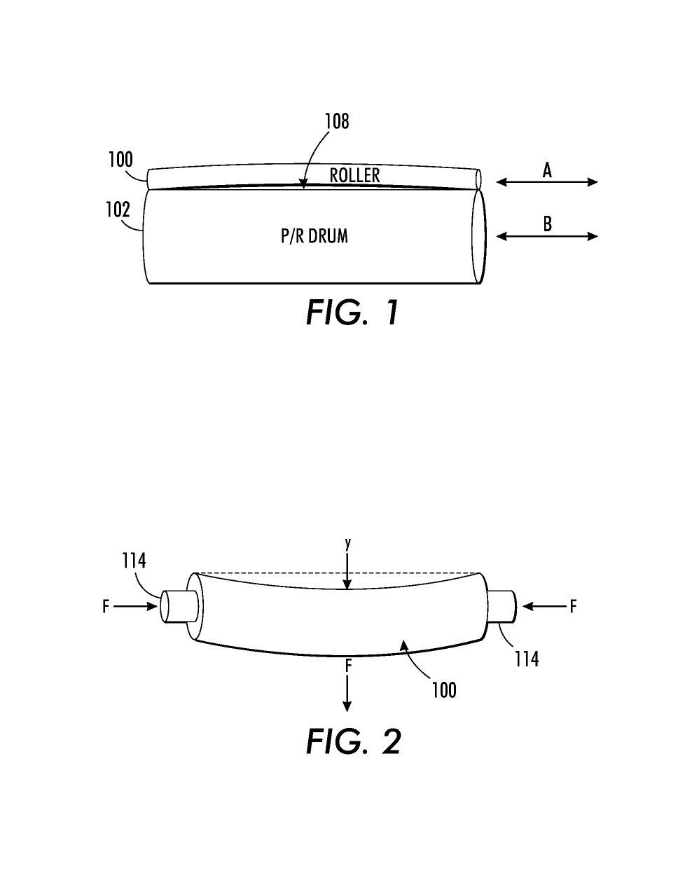

FIG. 1 illustrates two rollers 100, 102 aligned with their long axes in parallelism. In practice, machining a roller may result in non-straight shape of the roller, such as a curved roller 100 as in FIG. 1, where the deviation of the centre from the end of the roller is at the order of hundreds of micrometers or even millimeters, and can cause a gap 108 in the nip area. With the increase of aspect ratio of the roller, the curvature is further increasing. Although ultra-precision machining process helps in satisfying the requirements on straightness of a finished roller, the procedure is elaborate and the cost is high (to be suitable for both experimental setup and final batch production). Consequently, efficient conformal contact between two roller surfaces has been routinely implemented by increasing the thickness and lowering the stiffness of the elastomeric layer as coated on one roller, and therefore hardly deforming the layer. Such deformation must completely compensate for the maximum gap 108 between two surfaces, generally at the order of millimeter. The involved pre-load force required for deformation is also very high, which can cause faster wear rate on the surfaces of both rollers during contact rotation.

Such surface non-uniformities are even more pronounced for a miniature contact roller with a high respect ratio and a very thin layer coating and it may not be possible to achieve full deformation of the thin layer to completely fill the gap between the rollers. Further, this could cause collapse of any features on the layer.

In view of the issues, the methods and structures herein position the axis of the rollers in a non-parallel alignment to provide sufficient conformal contact. FIG. 2 is a side view diagram of one of the rollers 100, supported by a frame 114 (shown in greater detail in FIG. 5). The frame 114 applies force F to ends of the first roller 100 to bow the first roller 100 toward the second roller 102. The lateral forces F shown in FIG. 2 cause the roller 100 to bow downward to a maximum deflection y. The result of the force F is shown as the downward arrow F in FIG. 2. Therefore, as shown in FIG. 2, force F loading at each end of the roller is applied by the frame 110 to bend the roller to make in contact with another roller surface 102. According to beam theory, the pre-load F to force two cylindrical surfaces into contact can be calculated by

$$F = \frac{6 π E {D}^{4}}{{L}^{3}} y \qquad ( 1 )$$

where E is the Young's modulus of the roller, assumed equal to ˜30 GPa (steel) in this disclosure, L is length of the roller as 370 mm, D is diameter of the steel shaft of the roller as 4 mm, and y is the maximum gap assumed as 1 mm. Therefore, the required force is calculated as ˜2.86N.

In one specific example, for contact between a diameter Φ6 mm miniature roller with soft elastomeric layer, such as polydimethylsiloxane (PDMS), and a photoreceptor (P/R) drum with diameter Φ60 mm. In this example, it is assumed that the deformation only happens on the PDMS layer, because the Young's modulus of PDMS is only 5 Mpa, at least two-order smaller than the Young's modulus of P/R˜1.2 Gpa. According to Hertz contact theory, for two cylindrical surfaces, the maximum deformation on PDMS layer for contact between two crossed cylinders is:

$${d}_{max} = {( \frac{3 F ( 1 - {v}^{2} )}{4 E {R}^{1 / 2}} )}^{2 / 3} = 1.09 mm \qquad ( 2 )$$

The minimum deformation on PDMS layer for contact between two cylinders with parallel axes is:

$${d}_{min} = \frac{4 F}{π E L} = 9 μ m \qquad ( 3 )$$

where R is the radius of the miniature roller; L is the length of the miniature roller; and v is the Poisson ratio.

Thus, these two possible contact examples between rollers is a minimum deformation for contact between two crossed cylinders positioned to have perpindicular axis; and maximum deformation for contact between two cylinders positioned to have parallel axes.

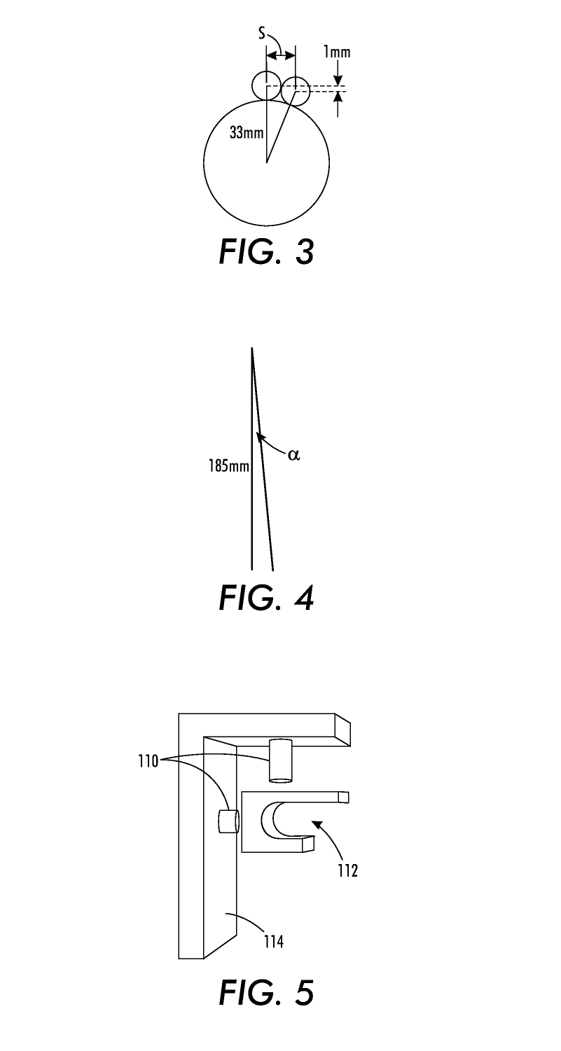

In this non-parallel alignment method, the angle between two axes of the cylinders to make two rollers in complete contact can be determined based FIGS. 3-4:

$$\begin{matrix}s = \sqrt{{33}^{2} - {32}^{2}} = 8 mm & ( 4 ) \\ α = \frac{8}{185 π} \times 180 ° ≅ 2 ° & ( 5 )\end{matrix}$$

This angle is very small so that the real deformation on most part of the PDMS layer surface is much closer to 9 μm, much smaller than 1 mm. Therefore, 100 μm to 1 mm thickness of PDMS layer is far enough to satisfy the efficient conformal contact.

From Eq. (3), it can be further seen that for traditional parallelism alignment method, the increase of the roller length will cause larger pre-load as required to deform the layer coating to ensure the dₘᵢₙ equal to the gap; it becomes worse for stiffer material. However, based on the parallelism of the methods and devices herein, one can always adjust the angle between two axes to reduce the required pre-load for a stiffer material.

Further, with the methods and devices herein using rigid materials to make the roller is not always required in practical alignment; because, from Eq. (1), the less rigid roller can actually reduce the required force to bend the roller into contact with another cylinderical surface. This can also reduce wear rate on both roller surfaces. In addition, a smaller diameter roller is actually preferred in this application for the same reason, which is different from traditional design, which always requires larger diameter, stiffer, and shorter rollers to maintain straightness for better contact. In addition, with devices and methods herein, the surface roughness is not critical because bending the roller compensates for conformal contact. In addition, with devices and methods herein the thickness of PDMS layer on the roller can be less than 1 mm, which is desirable for current designs.

FIG. 5 illustrates another view of the exemplary frame member 114 used to support a roller and adjust the axis of the roller to place the roller in conformal contact with the surface of another roller. The frame 114 includes axis adjusters 110 and a roller holder 112 made of PTFE or other plastics. The roller holder 112 is used to clamp one end of a roller and the roller can freely rotate within the roller holder 112 because of the low friction surface. Outside of the roller holder 112, an adaptor to blade holder can be utilized to contrain the movement of the roller holder 112 within allowable range. The two axis adjusters 110 are applied to adjust the position of the roller holder 112 up, down, forward, backward, etc. Therefore, the proposed non-parallism method/structure can be implemented through their adjustments.

While one example of a device that can alter the axis of one roller relative to another is shown in FIG. 5, those ordinarily skilled in the art would understand that any form of adjustment device (such as adjustment screws or powered actuators connected directly to conventional roller axel mounts) could be utilized with embodiments herein and that the methods and structures herein are not limited to the exemplary structure illustrated in FIG. 5.

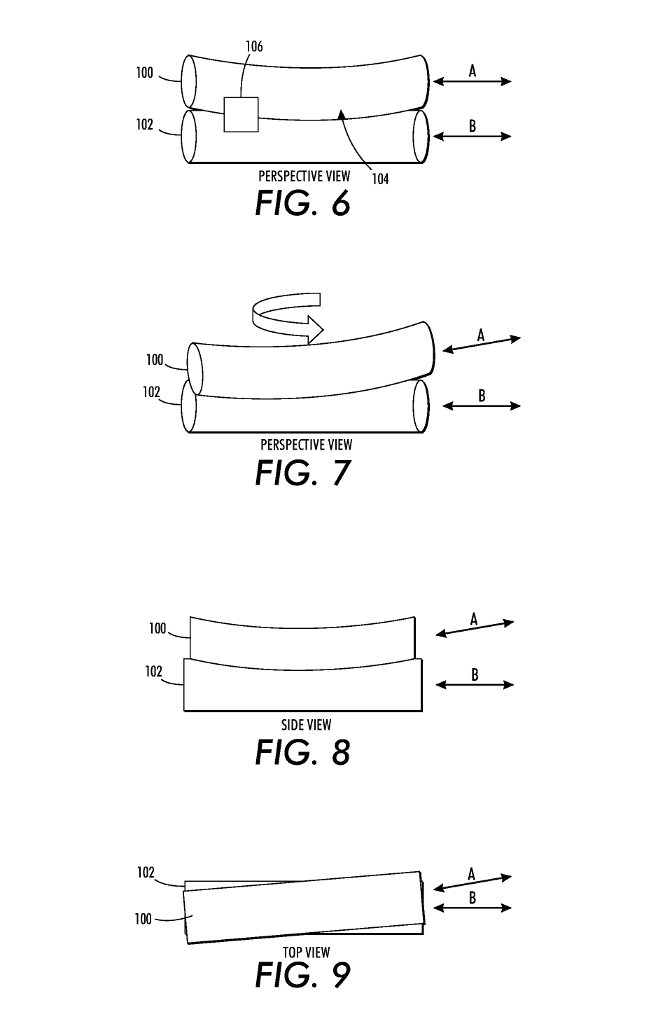

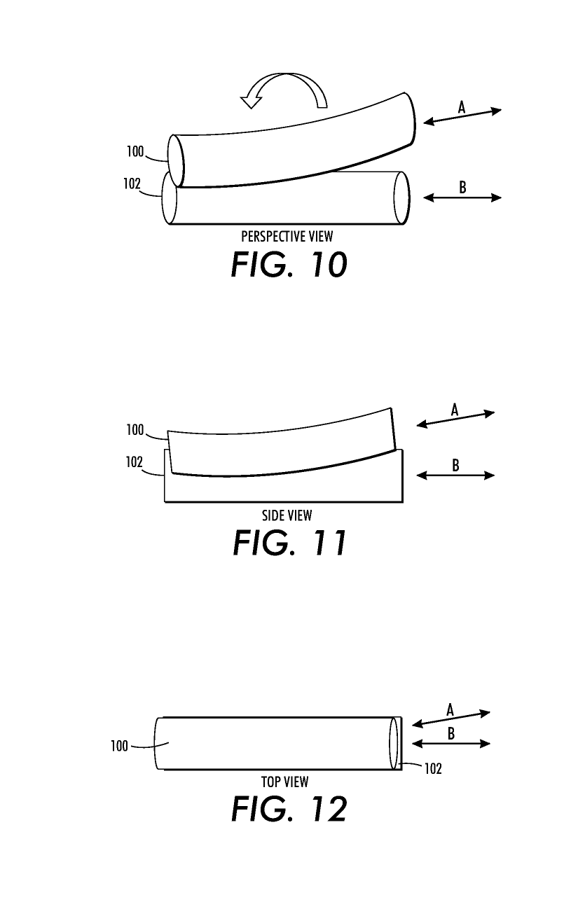

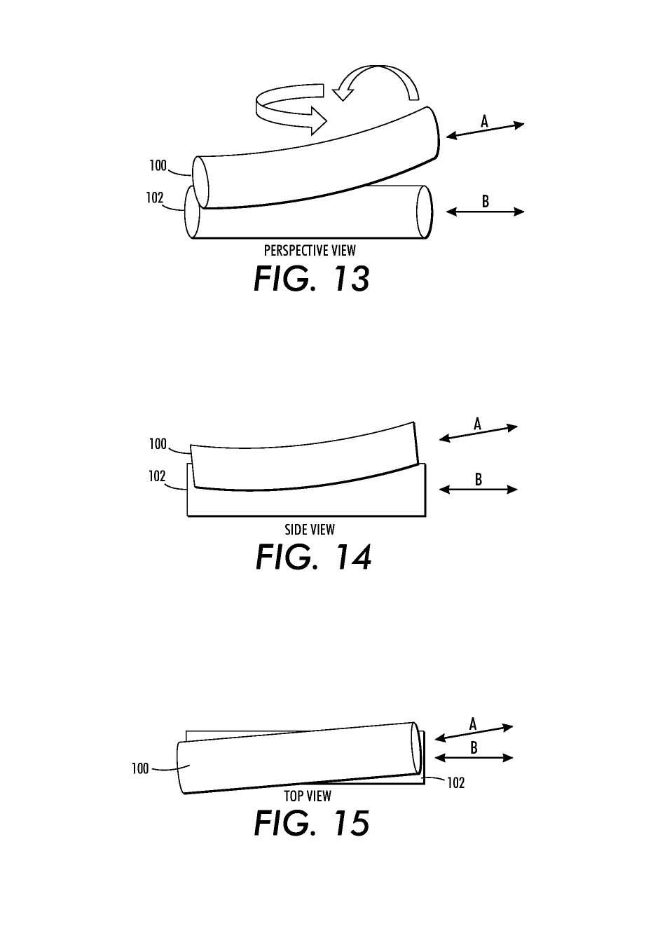

As shown in FIG. 6, a pair of opposing rollers can be included within, for example, a paper path of a printing device. The pair of opposing rollers comprises a first roller 100 and a second roller 102 contacting the first roller 100 to form a nip 104 between the rollers. Surfaces of the first roller 100 and the second roller 102 can have different hardness measures (as measured by the stiffness of the elastomeric layer). In FIGS. 6-15 roller 100 is subjected to side compressing force F (as shown in FIG. 2) and is bowed toward roller 102; however, in reality such bowing is very slight, such bowing of roller 100 is intentionally greatly exaggerated to illustrate the bowing in the figures. For purposes herein, the bowing experienced by roller 100 forms a continuous arc of the axis and surface of roller 100 from one end of roller 100 to the opposite end of roller 100. Additionally, the axis of a roller is considered the center line about which the roller rotates in discussions herein.

Further, such rollers are flat rollers (other than the bowing discussed above). Therefore, the surface of each roller is substantially parallel to the roller axis along the full length of each roller (from one end of each roller to the opposite end of each roller) and the diameter of each roller is substantially consistent along the full length of each roller (although the rollers can be different sizes and have different diameters). Because of surface curves and irregularities in the rollers surfaces caused by wear, manufacturing tolerances, etc., (as opposed to intended diameter changes of cone shaped or elliptical rollers) the nip 104 can have one or more unintended gaps (or areas of reduced nip pressure) at locations 108 where the surface of the first roller 100 partially or fully separates from the surface second roller 102, as shown for example in FIG. 1.

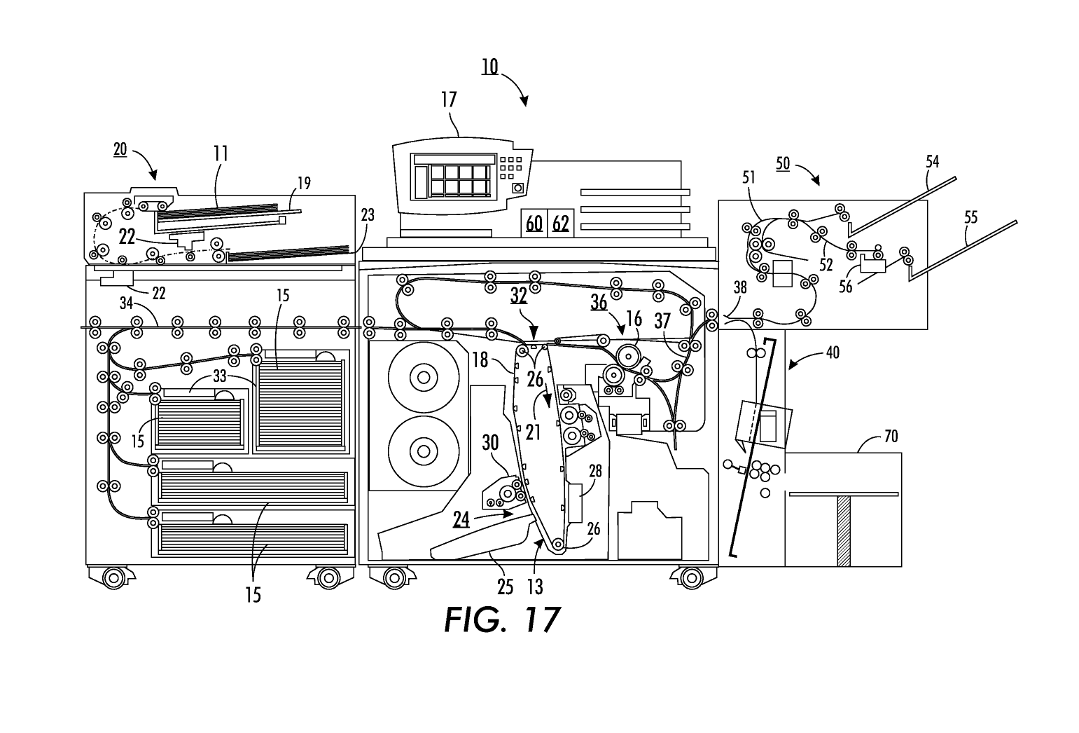

A frame 114 (FIG. 5) holds the first roller 100 and the second roller 102. An optional detector 106 (optical detector, pressure detector, electrical/inductive detector, air pressure detector, sonic detector, etc.) can be operatively connected to the controller 60 (FIG. 17) and can automatically measure such gaps or to measure the pressure between the rollers. A manual or automatic axis adjuster 110 (FIG. 5) is operatively connected to the controller 60, the detector 106, and the first roller 100. For example, the axis adjuster 110 can be any structure from a manual screw adjuster to a fully automated actuator. The axis adjuster 110 (potentially automatically and dynamically) changes the angle of the axis of the first roller 100 (a first axis) relative to the axis of the second roller 102 (a second axis) based on the gap to position the first axis in a position other than parallel to the second axis.

The adjuster 110 changes the angle of the first axis relative to the second axis to reduce or eliminate the gap. More specifically, changing the angle of the first axis relative to the second axis reduces or eliminates one or more of the gaps, without increasing other gaps and without forming additional gaps. Therefore, changing the angle of the first axis relative to the second axis makes the contact between the two rollers more uniform, and allows the amount of pressure exerted between the rollers to be decreased, relative to a non-bowed, parallel roller structure. The angle of the first axis of the first roller relative to the second axis of the second roller can be, for example, from about 0.01° to about 30°, and the gap between the pair of opposing rollers can be, for example, from about 1 μm to about 1 mm. Also, the aspect ratio of the first roller can be larger than the aspect ratio of the second roller.

Further, the axis adjuster 110 can adjust the first axis in a single plane or in multiple planes. For example, as shown in perspective, side, and top views (respectively in FIGS. 7, 8, and 9) the adjuster 110 changes the angle of the first axis A of the first roller 100 relative to the second axis B of the second roller 102 based on the gap to position the first axis in a position other than parallel to the second axis. Note that in FIG. 6, the first axis A and the second axis B are shown as being parallel, before the first axis A is adjusted by the adjuster in FIGS. 6-14.

To the contrary, as shown in perspective, side, and top views (respectively in FIGS. 10, 11, and 12) the adjuster 110 changes the angle of the first axis A of the first roller 100 relative to the second axis B of the second roller 102 based on the gap to position the first axis in a position other than parallel to the second axis. Further, the axis change shown in FIGS. 6-8 is in a first plane (represented by a horizontal curved arrow), while the axis change shown in FIGS. 9-11 is in a second plane (represented by a vertical curved arrow) different from the first plane. In one example, the first plane and second plane can be at right angles (or other angles) to one another. As shown in perspective, side, and top views (respectively in FIGS. 13, 14, and 15) the adjuster 110 changes the angle of the first axis A of the first roller 100 relative to the second axis B of the second roller 102 in any direction within either of the first or second planes based on the gap to position the first axis in a position other than parallel to the second axis.

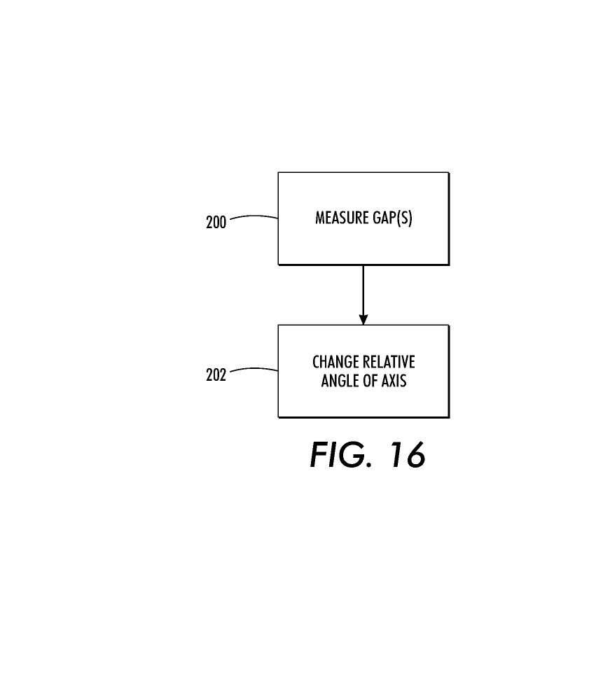

An exemplary method embodiment herein shown in flowchart form in FIG. 16 measures the gap between the pair of opposing rollers in item 200. This exemplary method also adjusts the axis adjuster to change the angle of the first axis of the first roller relative to the second axis of the second roller to position the first axis in a position other than parallel to the second axis in item 202. Again, changing the angle of the first axis relative to the second axis reduces or eliminates the gap makes the contact between the two rollers more uniform, and allows the amount of pressure exerted between the rollers to be decreased, relative to a non-bowed, parallel roller structure.

An exemplary printing apparatus herein can include for example, a controller, a paper path operatively (directly or indirectly) connected to the controller, a marking engine operatively connected to the controller and positioned along the paper path, etc. The marking engine places marks on print media transported by the paper path.

More specifically, referring to FIG. 17 a printing machine 10 is shown that includes an automatic document feeder 20 (ADF) that can be used to scan (at a scanning station 22) original documents 11 fed from a tray 19 to a tray 23. The user may enter the desired printing and finishing instructions through the graphic user interface (GUI) or control panel 17, or use a job ticket, an electronic print job description from a remote source, etc. The control panel 17 can include one or more processors 60, power supplies, as well as storage devices 62 storing programs of instructions that are readable by the processors 60 for performing the various functions described herein. The storage devices 62 can comprise, for example, non-transitory storage mediums including magnetic devices, optical devices, capacitor-based devices, etc.

An electronic or optical image or an image of an original document or set of documents to be reproduced may be projected or scanned onto a charged surface 13 or a photoreceptor belt 18 to form an electrostatic latent image. The belt photoreceptor 18 here is mounted on a set of rollers 26. At least one of the rollers is driven to move the photoreceptor in the direction indicated by arrow 21 past the various other known electrostatic processing stations including a charging station 28, imaging station 24 (for a raster scan laser system 25), developing station 30, and transfer station 32.

Thus, the latent image is developed with developing material to form a toner image corresponding to the latent image. More specifically, a sheet 15 is fed from a selected paper tray supply 33 to a sheet transport 34 for travel to the transfer station 32. There, the toned image is electrostatically transferred to a final print media material 15, to which it may be permanently fixed by a fusing device 16. The sheet is stripped from the photoreceptor 18 and conveyed to a fusing station 36 having fusing device 16 where the toner image is fused to the sheet. A guide can be applied to the substrate 15 to lead it away from the fuser roll. After separating from the fuser roll, the substrate 15 is then transported by a sheet output transport 37 to output trays a multi-function finishing station 50.

Printed sheets 15 from the printer 10 can be accepted at an entry port 38 and directed to multiple paths and output trays 54, 55 for printed sheets, corresponding to different desired actions, such as stapling, hole-punching and C or Z-folding. The finisher 50 can also optionally include, for example, a modular booklet maker 40 although those ordinarily skilled in the art would understand that the finisher 50 could comprise any functional unit, and that the modular booklet maker 40 is merely shown as one example. The finished booklets are collected in a stacker 70. It is to be understood that various rollers and other devices which contact and handle sheets within finisher module 50 are driven by various motors, solenoids and other electromechanical devices (not shown), under a control system, such as including the microprocessor 60 of the control panel 17 or elsewhere, in a manner generally familiar in the art.

Thus, the multi-functional finisher 50 has a top tray 54 and a main tray 55 and a folding and booklet making section 40 that adds stapled and unstapled booklet making, and single sheet C-fold and Z-fold capabilities. The top tray 54 is used as a purge destination, as well as, a destination for the simplest of jobs that require no finishing and no collated stacking. The main tray 55 can have, for example, a pair of pass-through sheet upside down staplers 56 and is used for most jobs that require stacking or stapling

As would be understood by those ordinarily skilled in the art, the printing device 10 shown in FIG. 17 is only one example and the embodiments herein are equally applicable to other types of printing devices that may include fewer components or more components. For example, while a limited number of printing engines and paper paths are illustrated in FIG. 17, those ordinarily skilled in the art would understand that many more paper paths and additional printing engines could be included within any printing device used with embodiments herein.

Many computerized devices are discussed above. Computerized devices that include chip-based central processing units (CPU's), input/output devices (including graphic user interfaces (GUI), memories, comparators, processors, etc. are well-known and readily available devices produced by manufacturers such as Dell Computers, Round Rock Tex., USA and Apple Computer Co., Cupertino Calif., USA. Such computerized devices commonly include input/output devices, power supplies, processors, electronic storage memories, wiring, etc., the details of which are omitted herefrom to allow the reader to focus on the salient aspects of the embodiments described herein. Similarly, scanners and other similar peripheral equipment are available from Xerox Corporation, Norwalk, Conn., USA and the details of such devices are not discussed herein for purposes of brevity and reader focus.

The terms printer or printing device as used herein encompasses any apparatus, such as a digital copier, bookmaking machine, facsimile machine, multi-function machine, etc., which performs a print outputting function for any purpose. The details of printers, printing engines, etc., are well-known by those ordinarily skilled in the art. The embodiments herein can encompass embodiments that print in color, monochrome, or handle color or monochrome image data. All foregoing embodiments are specifically applicable to electrostatographic and/or xerographic machines and/or processes.

In addition, terms such as “right”, “left”, “vertical”, “horizontal”, “top”, “bottom”, “upper”, “lower”, “under”, “below”, “underlying”, “over”, “overlying”, “parallel”, “perpendicular”, etc., used herein are understood to be relative locations as they are oriented and illustrated in the drawings (unless otherwise indicated). Terms such as “touching”, “on”, “in direct contact”, “abutting”, “directly adjacent to”, etc., mean that at least one element physically contacts another element (without other elements separating the described elements). Further, the terms automated or automatically mean that once a process is started (by a machine or a user), one or more machines perform the process without further input from any user.

It will be appreciated that the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims. Unless specifically defined in a specific claim itself, steps or components of the embodiments herein cannot be implied or imported from any above example as limitations to any particular order, number, position, size, shape, angle, color, or material.

What is claimed is:

1. A method comprising:
measuring a gap between a pair of opposing rollers, said pair of opposing rollers comprising a first roller and a second roller contacting said first roller to form a nip between said rollers, said nip having said gap at a location where said first roller separates from said second roller, and a frame holding said first roller and said second roller; and
adjusting an axis adjuster connected to said frame and said first roller to change an angle of a first axis of said first roller relative to a second axis of said second roller to position said first axis in a position other than parallel to said second axis, said changing of said angle of said first axis relative to said second axis one of reducing and eliminating said gap.

2. The method according to claim 1, further comprising applying force to ends of said first roller using said frame to actively bow said first roller toward said second roller.

3. The method according to claim 1, an angle of said first axis of said first roller relative to said second axis of said second roller being from about 0.01° to about 15°.

4. The method according to claim 1, said gap between said pair of opposing rollers being from about 1 μm to about 1 mm.

5. The method according to claim 1, an aspect ratio of the first roller being larger than an aspect ratio of the second roller.

6. The method according to claim 1, said adjusting of said axis adjuster adjusting said first axis in one of a single plane and a plurality of planes.

7. The method according to claim 1, said gap comprising a plurality of gaps, said adjusting of said adjuster one of reducing and eliminating one of said gaps without increasing others of said gaps and without forming additional gaps.

8. The method according to claim 1, said first roll being coated with a layer having a thickness from about 1 μm to 1 mm.

9. The method according to claim 1, a surface of said first roller being parallel to said first axis along a full length of said first roller from one end of said first roller to an opposite end of said first roller,
a diameter of said first roller being approximately consistent along said full length of said first roller,
a surface of said second roller being parallel to said second axis along a full length of said second roller from one end of said second roller to an opposite end of said second roller, and
a diameter of said second roller being approximately consistent along said full length of said second roller.

10. The method according to claim 1, said axis adjuster comprising one of a manual adjuster and an actuator.

11. An apparatus comprising:
a pair of opposing rollers comprising a first roller and a second roller contacting said first roller to form a nip between said rollers, said nip having at least one gap at a location where said first roller separates from said second roller;
a frame holding said first roller and said second roller; and
an axis adjuster connected to said frame and said first roller, said axis adjuster changing an angle of a first axis of said first roller relative to a second axis of said second roller to position said first axis in a position other than parallel to said second axis, said changing of said angle of said first axis relative to said second axis one of reducing and eliminating said gap.

12. The apparatus according to claim 11, said frame applying force to ends of said first roller to actively bow said first roller toward said second roller.

13. The apparatus according to claim 11, said axis adjuster one of manually and automatically adjusting said first axis in one of a single plane and a plurality of planes.

14. The apparatus according to claim 11, a surface of said first roller being parallel to said first axis along a full length of said first roller from one end of said first roller to an opposite end of said first roller,
a diameter of said first roller being consistent along said full length of said first roller,
a surface of said second roller being parallel to said second axis along a full length of said second roller from one end of said second roller to an opposite end of said second roller, and
a diameter of said second roller being consistent along said full length of said second roller.

15. A printing apparatus comprising:
a controller;
a paper path operatively connected to said controller;
a marking engine operatively connected to said controller and positioned along said paper path, said marking engine placing marks on print media transported by said paper path;
a pair of opposing rollers within said paper path, said pair of opposing rollers comprising a first roller and a second roller contacting said first roller to form a nip between said rollers through which said print media passes, said nip having at least one gap at a location where said first roller separates from said second roller;
a frame holding said first roller and said second roller;
a detector operatively connected to said controller and measuring said gap; and
an automatic axis adjuster operatively connected to said frame and said controller and connected to said first roller,
said axis adjuster automatically changing an angle of a first axis of said first roller relative to a second axis of said second roller based on said gap to position said first axis in a position other than parallel to said second axis, said changing of said angle of said first axis relative to said second axis one of reducing and eliminating said gap.

16. The printing apparatus according to claim 13, said frame applying force to ends of said first roller to bow said first roller toward said second roller.

17. The printing apparatus according to claim 13, said axis adjuster adjusting said first axis in one of a single plane and a plurality of planes.

18. The printing apparatus according to claim 13, said gap comprising a plurality of gaps, said changing of said angle of said first axis relative to said second axis one of reducing and eliminating one of said gaps without increasing others of said gaps and without forming additional gaps.

19. The printing apparatus according to claim 13, a surface of said first roller being parallel to said first axis along a full length of said first roller from one end of said first roller to an opposite end of said first roller,
a diameter of said first roller being consistent along said full length of said first roller,
a surface of said second roller being parallel to said second axis along a full length of said second roller from one end of said second roller to an opposite end of said second roller, and
a diameter of said second roller being consistent along said full length of said second roller.

20. The printing apparatus according to claim 13, said axis adjuster comprising an actuator.
